(19) United States
(12) Patent Application Publication
(10) Pub. No.: US 2013/0097014 A1
(43) Pub. Date: Apr. 18, 2013

(54) SYSTEM AND METHOD FOR AUTOMATICALLY COMBINING DIGITAL MEDIA INCLUDING ADVERTISING AND MUSIC CONTENT

(71) Applicants: John Francis Martin, Spring Valley, OH (US); Chaitanya Dalvi, Chicago, IL (US)

(72) Inventors: John Francis Martin, Spring Valley, OH (US); Chaitanya Dalvi, Chicago, IL (US)

(73) Assignee: AUXILIARY BAY , LLC, New York, NY (US)

(21) Appl. No.: 13/438,838

(22) Filed: Apr. 3, 2012

Related U.S. Application Data
(60) Provisional application No. 61/494,336, filed on Jun. 7, 2011.

(51) Int. Cl. G06Q 30/02

(52) U.S. Cl. CPC G06Q 30/0277; G06Q 30/0247
USPC 705/14.46; 705/14.73; 705/14.66; 705/14.58

(57) ABSTRACT

Two digital files are combined through an automatic process to create a third digital combination file. A media file is uploaded to a media file database and an advertising file is uploaded to an advertising database. A first advertising file is selected to be combined with a second media file using smart logic and analysis. The selected first advertising file and second media file are automatically combined to create a third, new, unitary combination file. The third new combination file is then made available to consumers/end users through download or streaming without charge. The artists who provide the media files may be compensated according to the number of times each of their songs/media are downloaded or streamed by a consumer/end user.

A portion of the disclosure of this patent application contains material that may be subject to copyright protection and is incorporated by reference herein.

### TECHNICAL FIELD

The present invention relates to the seamless combination of two media forms. In particular, the invention is directed to automatically combining a digital song/music with a digital advertising file to create a free, downloadable combination file. In one embodiment, the combination file is downloaded to the end user and stored on the end user's media storage device such as a computer or phone or both. In another embodiment, the combination file is streamed to the end user and stored in the cloud for future retrieval by the end user. This invention also provides business opportunities for lesser-known, unsigned artists to obtain publicity and receive an income and for advertisers to identify and target potential customers using demographic data.

### BACKGROUND

Independent, unsigned musical artists have traditionally found it difficult to obtain exposure to their songs and culture, not to mention making a living wage. Several web-based systems have been tried to promote individual artists that combines the ability of users to obtain downloadable copies of their songs and to learn about the artist and their culture. Typically, these web-based systems obtain advertisers who pay to incorporate banner ads into the website that are viewed by the user when downloading or listening to the song or artist information. For example see, www.mp3.com, Everad.com (no longer an active music website), and Riffage.com (no longer an active music website) as described in the articles “Ads Take Aim At Online Music”; Wired; Christopher Jones; Mar. 3, 2000 and “Bands and Fans Rub Elbows on Riffage.com: New music portal promises personalization for fans and a low-cost distribution medium for bands”; PCWorld; Christian McIntosh; Jun. 7, 1999.

In some of current web-based systems such as www.mp3.com and www.itunes.com, a portion of the downloadable music is free while the customer must pay for the majority of the music in their database. Typically, the free downloadable songs are directed to lesser-known and/or unsigned artists and given away as promotional material. However, the promotion of these artists is not effective and the artists do not receive significant income from these sources.

Software programs and websites currently exist that allow a person to combine an audio digital file, such as song, with another digital file to create a combined new digital file. For example, see Sound Forge™ Pro 10 and ACID Pro 7 software as described at www.sonycreativesoftware.com/products. However, these software programs only allow the individual to create the new file by joining two media files through manual means. While appropriate on a small scale, it is not functional for the large-scale merger of many media forms simultaneously. One web-based system, www.audioadmaker.com, provides a manual mechanism for advertisers to combine free music with their advertising content to prepare a new combination multimedia file. This website provides 100 royalty-free 60 second commercial music beds that can be used with a commercially available studio mixing and recording software and proprietary scripting software to manually make professional, broadcast quality audio ads. However, this website provides only a limited music database and does nothing to promote or compensate artists.

In view of the above, an alternative method of combining media forms in an automated manner is needed that promotes and compensates artists and allows advertisers to reach new targeted consumers.

### BRIEF DESCRIPTION OF THE DRAWINGS

FIG. 1 is a diagram of system architecture according to one embodiment of the invention.

FIGS. 2a-2c are flow diagrams of one embodiment of the invention.

FIG. 3 is a sample screenshot of a web page according to one embodiment of the invention.

FIG. 4 is a sample screenshot of another web page according to one embodiment of the invention.

### SUMMARY

A system and method of joining two digital files through an automatic process to create a third, digital combination file are described below. In these inventions, a media file is uploaded to a media file database and an advertising file is uploaded to an advertising database. A first advertising file is selected to be associated with a second media file using analytics and combination software. The selected first advertising file and second media file are automatically combined by a combination software engine to create a third, new combination file. The third new combination file is then made available to consumers/end users without charge through a download or streaming process. The artists who provide the media files may be compensated according to the number of times each of their songs/media are downloaded or streamed by the user.

In another embodiment, a system and method for joining two digital files through an automatic process to create a third digital combination file are described. The system includes a media file database; an advertising file database and an ad engine server that are connected through a network that communicates with the media file database and the advertising file database. A combination software engine and analytics software are provided within the ad engine server for automatically combining a media file obtained from the media database with an advertising file obtained from the advertising database to create a third, new combination file. The third new combination file is then made available to consumers/end users without charge through a download or streaming process. The artists who provide the media files may be compensated according to the number of times the song/media is downloaded or placed into a music library, regardless of how many times the song/media is played within those mediums.

The system and method may also include a device for tracking the number of times an artist's song/media has been downloaded or streamed and for calculating the artist's compensation proportionally to this number.

### DETAILED DESCRIPTION OF EMBODIMENTS

The invention pertains to systems and methods for automatically combining two digitals files into a new third digital file that includes an artist's song or other media and a company's advertising. As used herein: “song” or “music” includes, but is not limited to, a work of any length comprised of audible sounds arranged in time and possessing a degree of melody, harmony, rhythm, and timbre; “media” includes, but is not limited to, songs, music, video, images, podcasts, audio books, e-book and any combination or portion thereof.

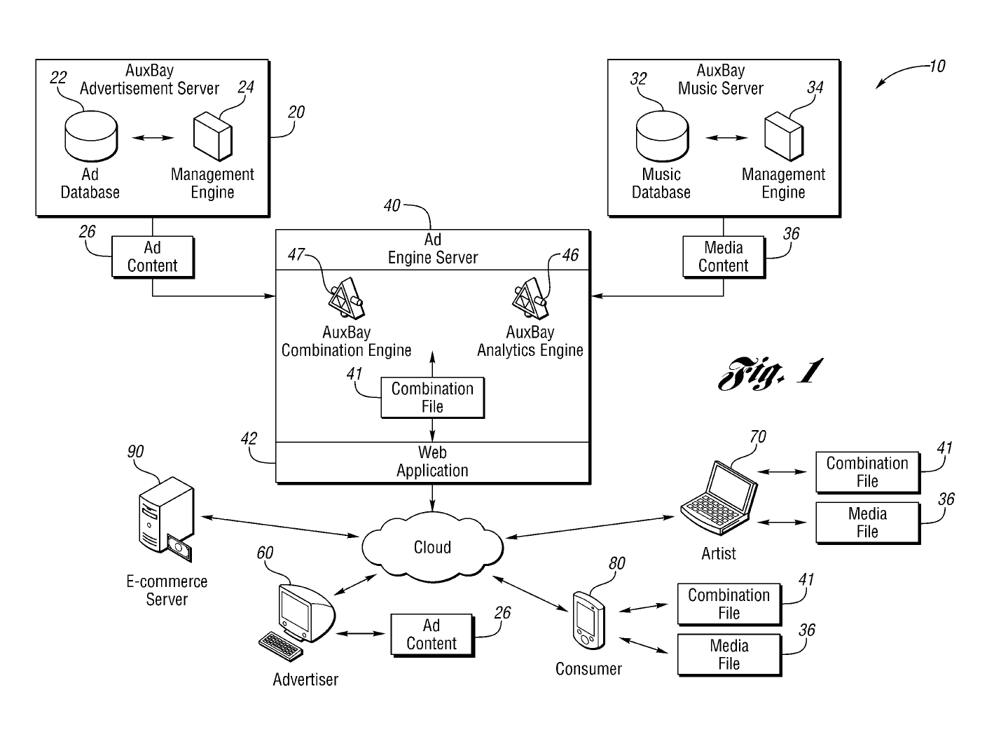

FIG. 1 provides an overview of one embodiment of a system 10 for use in implementing the “AuxBay service.” The AuxBay system architecture may include an Ad Server 20, a Media Server 30, an Ad Engine Server 40, and an Aux Bay Web Application 42. The Ad Server 20 stores and maintains a catalog of all the various advertisers, their content, ads and other promotional material. The Media Server 30 stores and maintains all of the media content including, but not limited to songs, music, video, images, podcasts, audio books, e-book and any combination or portion thereof. The Ad Engine Server 40 stores and maintains a combination software engine 46 and analytics software 47. The Web Application 42 is the web based, front end application that is accessible to the end users through an internet browser. These components may exist on separate servers or be located within a single server that performs all functions of the individual servers. Alternatively, the data and software associated with the Ad Server 20, Media Server 30, Ad Engine Server 40 and Web Application 42 may be stored within the cloud 50. The servers are connected directly or to each other through a data network (not shown).

Advertisers and artists may sign up for the AuxBay service using advertiser terminals 60 and artist terminals 70 to provide their advertising content and media content, respectively, to the appropriate server. Consumers may communicate using multiple terminals 80 through the network to make their selections and obtain downloadable or streamed files. An e-commerce server 90 may also operate through the network to track the payment of advertising fees and artist's income, the latter which may be based on the number of times that artist's songs/media are downloaded or streamed. One skilled in the art will appreciate that the servers and terminals may include the appropriate hardware including a processor, memory and other conventional electronic components and may be programmed with processor-executable instructions to facilitate communication via the network to perform aspects of the invention. It is envisioned that the network is not limited to any particular type of network and may include one or more wide area networks (WAN) such as the internet, one or more local area networks (LANS), public switched telephone networks (PSTN) and any combinations of these network types. The advertiser terminals 60, artist terminals 70 and consumer terminals 80 can be any type of PC or cellular phone device capable of communicating over a network such as the internet, using any type of web browser and user interfaces. In one embodiment, a system includes a display device, a storage unit and a browser to display data. The display device may be, for example, a liquid crystal display (LCD), a light-emitting diode display (LED), an electroluminescent display (ELD), a cathode ray tube (CRT), a plasma display panel (PDP) and the like. The storage unit may include, but is not limited to, memory such as RAM, ROM, DRAM and the like; storage devices and their media such as hard disk drives, optical disc drives, flash memory (e.g. USB flash drives or keys), DVD, CD-ROM, CD-R/W, floppy disks, magnetic tape, paper tape, punched cards, standalone RAM disks, Iomega Zip drives and the like; off-line or other removable mass storage media that is connected according to the system demand. A browser may include a user interface by which people (users) interact with a machine. The user interface typically includes hardware (physical) and software (logical) components. User interfaces exist for various systems, and provide a means of input, which allows the users to manipulate a system and output, which allows the system to indicate the effects of the users' manipulation.

In one embodiment of the invention, the Ad Server 20 contains a database of advertising files 22 and hardware and software, collectively referred to as the Ad Server management engine 24. Similarly, the Media Server 30 contains a database of songs, music or other media 32 and hardware and software, collectively referred to as the Media server management engine 34. Both the ad server management engine 24 and the media server management engine 34 allow the ad server 20 and media server 30, respectively, to communicate with the ad engine server 40 and to transfer data, execute commands, and to perform any other function as needed to implement the AuxBay service.

The ad engine server 40 contains a combination software engine 46 and analytics software 47 that combines a first, digital advertising file 26 provided by the ad server 20 and a second, digital song 36 provided by the music server 30 to create a third, new digital file 41 that includes the content of both files. The software may include, but is not limited to application software, firmware, resident software, microcode and the like. The combination software 46 and/or analytics software 47 may be written in ASP.net code; however, other software code may be used. Once the two digital files are combined, the third file 41 is a continuous, unified, or unbroken digital file that is absent of any significant audible breaks or other characteristic that classifies the third digital file 41 to be two discrete files instead of a single, unitary file. Small breaks in the audible portion or a drop in the noise floor may be present due to the automated editing techniques used in this invention. Alternatively, audible breaks or drops in the noise floor of any length may be inserted in the third digital file 41; nonetheless, the file remains as a single, unitary file. Both the advertising file 26 and music digital file 36 can be of any type including, but not limited to, audio files (e.g., MP3, MPEG4, AAC, WMA), or music videos (e.g., QuickTime®, AVI).

Artists can sign up to be a part of the AuxBay service and submit their songs/media content 36 to the media database 32. Advertisers can also sign up for the AuxBay service and submit their advertising files 26 to the ad database 20. During the signup process, the artist may identify demographic information/factors that are known about their typical listeners/followers, such as age, gender, location, zip code, race, socio-economic status, political views, and the like. In addition, the artist may identify the genre or type of their music. Typical genres/types include, but are not limited to, popular, alternative, blues, Christian, classical, comedy, county, easy listening, electronic, family, folk, Halloween, hip hop, indie, jazz, Latin, pop, R&B, rock, songwriters, workout and world The advertisers may specify the genre/type of music, artist, or culture with which they would like their products or services to be associated. Alternatively, advertisers may identify additional demographic information similar to the demographic information provided by the artists.

The ad engine server 40 may automatically combine the first digital advertising file 26 with the second digital song 36 using analytics software 47 to create a new, digital, unitary combination third file 41 by matching demographic information provided by the artist to similar demographics identified by the advertiser. For example, if an artist and an advertiser identify the same zip code, the ad engine service 40 may combine the song/media file 36 and advertising file 26 to make the new digital file 41 that will appeal to people living or working in and around that zip code. In one embodiment, the advertising file may last approximately 3 to 30 seconds, preferably between 3 to 5 seconds or 3 to 10 seconds. However, longer advertising files up to about 6, 8, 10, 15, 20, 25, 30, 35, 40, 50, 60, 70, 80, 90 or 100 seconds may be used. In one embodiment, the first digital advertising file 26 may be placed within the third, combination file 41 to play before the second digital song/media 36. In other embodiments, the first digital advertising file 26 may be placed to play at the end of the second digital song/media 36.

In one embodiment, end users are able to download the combined file 41. In other embodiments, the end users are able to stream the combined filed 41 from an internet or hosted “cloud” server 50 to a personal media player 80, 70 by means of a wireless streamed data source. The combined file 41 may be made available to end users of the service who have access to a proprietary web application 42. The combined file 41 or a portion thereof may be played as many times as an end user would like and may continue to play a short advertisement before every play as long as the song is in the library of the user. If a song or other auditory file 36 is added and listened to, and thus paid for by an advertiser, then deleted by the user and re-added at a later date to the same user's library, the initial advertiser may retain the right to include an advertising file 26 in front of that particular media file 36 on that specific library, or to additionally allow other advertisers an option to purchase the advertising space.

The combined file 41 and media file 36 may be held in a personal web hosted library that may be accessed by one individual. When a combined file 41 is added to a personal library, an advertiser may be required to pay the artist/creator of the music or other auditory file 36 in exchange for the user agreeing to listen to an ad file 26 before their streamed music. A predetermined amount of currency may be paid in return for the use of advertising space. By paying the artist/creator for the right to advertise before the music in an individual's library, the advertiser has the ability to change the advertisement that is played as the advertiser sees fit and this new or changed ad will immediately replace the ad previously held and played. This advertisement may provide the ability to update an advertisement for a brand in order to stay current.

An advertiser may also have the ability to play sequential ads if they would like. After the specified number of plays have occurred as specified by an advertiser, or similarly acting party, a follow up or multiple follow up ads may be subsequently played according to proprietary algorithmic settings and requests by the advertising firm or system manager. The benefit of sequential ads offer an advertiser a way to advertise a more complex message by only using quick bursts of information over a series of time. In the event that a combined file 41 is added to a personal library and not played, after thirty (30) or otherwise negotiated number of calendar days, the combined file 41 may become inactive and the payment that is pending for payment of use to a particular artist may be fully refunded to the advertiser. In the event that the combined file 41 is inactive and then played, the initial advertiser may have the ability to re-instate the purchase or offer that advertising space to another advertiser.

If at any point an advertiser no longer wishes to advertise through music, a particular genre, artist, or other bias, that the advertiser has purchased space in front of, the space may be placed on auction and bid upon by interested advertising parties. A variable fee in the range of 1%-50% of the agreed upon auction price may be charged for transfer services to the buying party for the transfer of service.

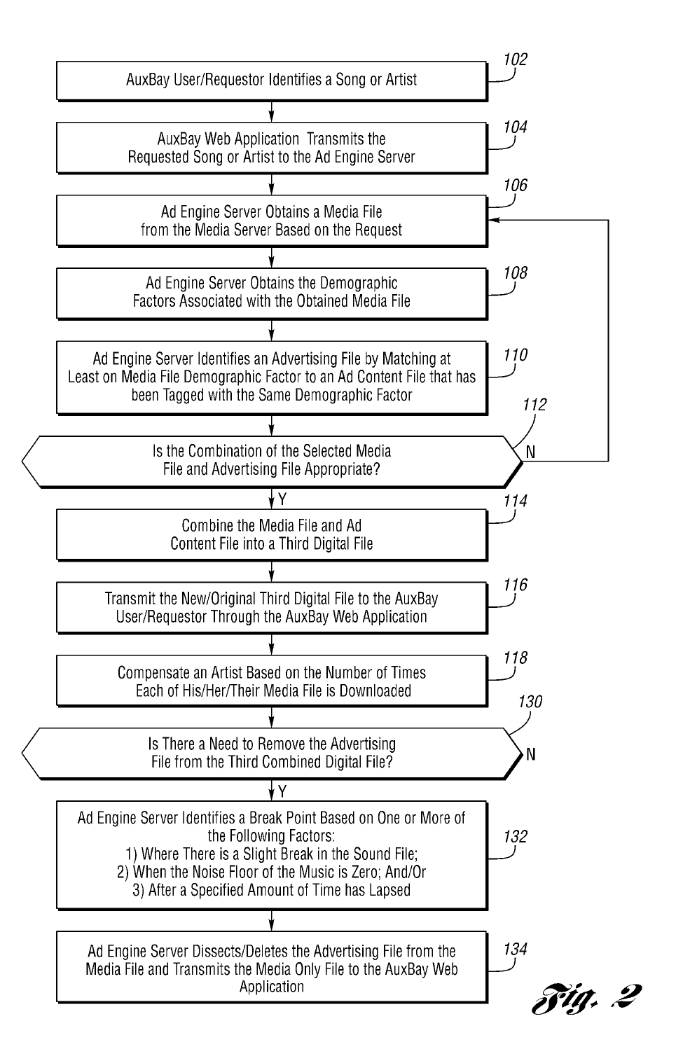

FIGS. 2a and 2b illustrate one embodiment of processes 100 for use with the AuxBay system. At 102, an AuxBay end user requests to download or stream a specific song(s) or identifies a particular artist at the AuxBay web application 42. At 104, the AuxBay web application communicates with the Ad Engine Server 40 to obtain the requested media content 26. At 106, the Ad Engine Server 40 invokes the combination software engine 46 and analytics software 47 to fetch the appropriate media file(s) 26 from the Media Server 30 as requested by the user. At 108, the Ad Engine Server 40 also obtains the demographic factors assigned to this song/media 36. At 110, once the media file(s) 36 has been received by the Ad Engine Server 40, the combination software engine 46 works with the analytics software 47 to retrieve an appropriate advertising file 26 from the Ad Server 20. As an example, the Ad Engine Server 40 obtains all the demographic factors associated with the selected media file(s) 36 including, but not limited to, age, gender, location, zip code, race, music genre, socio-economic status, and social/political views. The Ad Engine Server 40 communicates with the Ad Server 20 to identify at least one advertising file 26 that has been associated with at least one of the same demographic factors associated with the media file. At 112, once an advertising file 26 has been selected, the Ad Engine Server 40 may perform a verification step to ensure that an appropriate advertising file 26 has been attached to an appropriate media file 36. In one embodiment, the Ad Engine Server 40 performs this verification by reviewing the demographics supplied by the advertiser and confirms that match is appropriate. For example, it may not be appropriate to add a punk or rock song to an advertisement for a large luxury car that is most often bought by persons over 50 years. In another embodiment, the Ad Engine Server 40 may perform this verification by determining whether the proposed combined file 41 has been provided too many times to the same or different requestor or whether the same ad file 26 has been combined with more than one of the artist's songs 36. In either case, the ad content 26 may not be effective when it is overused with any song or group of songs 36. At 114, once a unique combined file 41 has been identified, the Ad Engine Server 40 uses the combination software engine 46 to combine, attach and embed it within the media file. At 116, once the process has been completed by the Ad Engine Server 40, the new/original, unitary third digital combined file 41 is sent to the front end AuxBay Web Application 42 and is made available to the AuxBay end user/requestor for download or streaming. “Download” means any transfer of a file from a web-based server to a requestor's personal or portable computer that can be stored and used by the requestor and the requestor gains ownership of the transferred file. Downloading is contrasted from streaming in that the streamed file cannot generally be stored or used by the requestor and the requestor does not gain ownership of the transferred file. At 118, the system tracks the number of times a particular song/media file 36 is downloaded and then compensates the artist in an amount that is proportional to the number of times that song/media file 36 has been download or streamed.

FIG. 2c illustrates another embodiment of a process for use with the AuxBay system. At 130, a decision is made whether it is desirable to remove the advertising file 26 from the third digital combined file 41 to leave only the original song/media file 36. At 132, the Ad Engine Server 40 may delete/dissect the advertising file 26 from the media file 36 by identifying 1) where there is a slight break in the sound file; 2) when the noise floor of the music is zero; and/or 3) after a specified amount of time has elapsed. At 134, once the Ad Engine Server 40 identifies the appropriate break point between the advertising file 26 and the media file 36, the combination software engine 46 and/or analytics software 47 is used to delete the advertising file 26 and provide only the media file 36 to the AuxBay end user/requestor.

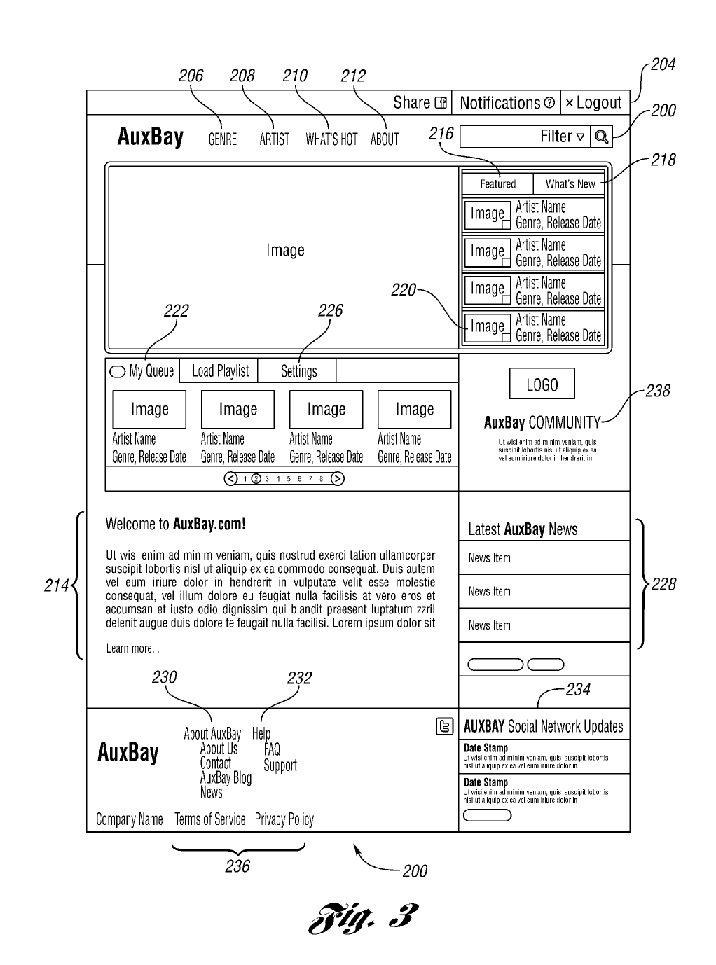

FIG. 3 shows a sample screenshot for one embodiment of the AuxBay service. The following user interfaces may be included on one or more web pages 200 associated with the AuxBay service:
a. Search box or link to a search page 202
b. Login/Logout 204
c. Genre selection 206
d. Drop down list by Genre (not shown; available when the genre 206 link is selected)
e. Artist selection 208
f. Drop down list by Artist (not shown; available when the artist 208 link is selected)
g. What's Hot selection 210
h. Drop down list of Top Songs/Popular Songs (not shown; available when the What's Hot 210 link is selected)
i. About selection 212
j. Welcome to Aux Bay . . . Learn More→About
k. Featured Songs 216
l. What's New—New Songs 218
m. Special Feature—Sponsored Songs 220
n. My Queue 222
o. Load Playlist 224
p. My Settings 226
q. News 228
r. About AuxBay, including About Us, Contact, AuxBay Blog, and News links 230
s. Help, including FAQs and Support 232
t. Twitter Updates Feed 234
u. Copyright Notice, Terms of Service and Privacy Policy 236
v. AuxBay Community (238)
w. Individual—Username, Zip code, Gender and Age (configurable fields) (not shown)
x. Artist—Target Demographic, Target Age Range, Explicit Language (not shown)
y. Advertiser—Type of music with which the advertiser wants to associate (not shown)
z. AuxBay Concerts—identified by city (not shown)
aa. Training Content—Sponsored Video (not shown)
bb. Notification (not shown)
cc. Artist Concerts (not shown)
dd. Albums (not shown)
ee. Songs (not shown)
ff. Artist Activity (not shown)
gg. Facebook Login Integration (not shown)
hh. Other links that may be visible in the graphic designs (not shown)

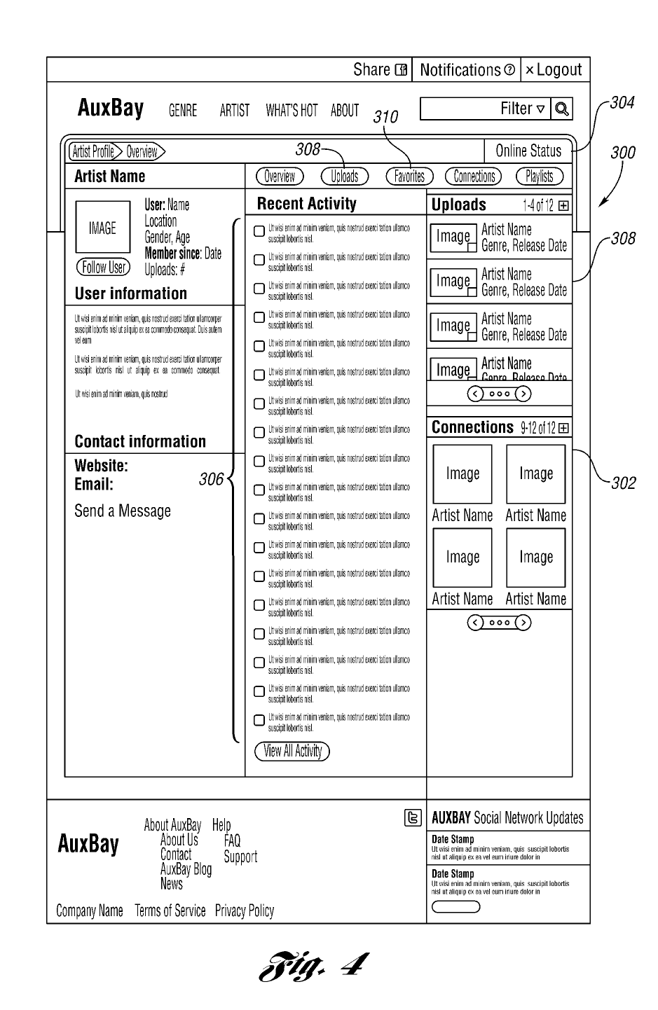

FIG. 4 shows a sample screenshot of a sub-page 300 of the AuxBay website used to feature one or more artists. The artist sub-page 300 may include the following user interfaces:
a. Connection→Similar Artist 302
b. Messages to Artists 304
c. Activity 306
d. Uploads 308
e. Favorites 310
f. Other links that may be visible in the graphic designs (not shown).
   The artist sub-page may also include user interfaces that provide information on influential artists or users, suggested artists, new artists, top artists (those being downloaded or streamed the most), and trends on what an end user's Facebook, Twitter or invited friends are downloading or streaming to their libraries. A “What's Hot” sub-page may include user interfaces that identifies and allows end users to select “hot songs”, “hot artists”, “hot playlists” and “hot listeners” amongst other features.

End users/consumers may access the AuxBay service using web pages like examples 200 and 300 shown above and any number of web pages. By using the Genre 206, Artist 208, What's Hot 210 and About 212 drop down user interfaces or the search box 202 user interface, the end user/consumer can select one or more media files 36 that can be downloaded or streamed without charge to their personal consumer terminal 80. The downloaded or streamed file will typically be a combination file 41 that includes both ad content 36 and media content 36. If a song or other media is not associated with an advertising file 36, a small fee may be required to download the song. Artists may be compensated based on the number of times their media is downloaded or streamed by an end user/consumer. Advertisers may be charged predetermined fees for associating their adverting files 26 with a particular artist using an Advertiser sub-page (not shown) and the e-commerce server 90.

Advantages of the AuxBay service and system as described above include:
a) Exposing consumers to lesser known and/or unsigned artists;
b) Marketing of products and services to consumers who might not be available through conventional marketing channels;
c) Deterring piracy of music by making the downloadable music files free to the end user/consumer; and
d) Compensating lesser known and/or unsigned artists with reasonable compensation.

This inventions described above fill a clear and present need in the technology field by providing an advertising partner an opportunity to pair their advertisement with an artist that share the collective work to the general public while offering a method of payment and compensation to the contributing artist. The inventions may be applied to the internet cloud database or be web-based. The internet cloud database inventions offer a method of tracking analytics and portability that downloaded files do not offer such as, tracking the number of plays, and tracking the physical location that the song is being played in.

The inventions described herein are preferably implemented by software, but can also be implemented in hardware or a combination of hardware and software. The inventions can also be embodied as computer readable code on a computer readable medium. The computer readable medium is any data storage device that can store data, which can thereafter be read by a computer system. Examples of the computer readable medium include read-only memory, random-access memory, CD-ROMs, flash memory cards, DVDs, magnetic tape, and optical data storage devices. The computer readable medium can also be distributed over network-coupled computer systems so that the computer readable code is stored and executed in a distributed fashion.

The many features and advantages of the present inventions are apparent from the written description and, thus, it is intended by the appended claims to cover all such features and advantages of the invention. Further, since numerous modifications and changes will readily occur to those skilled in the art, the inventions should not be limited to the exact construction and operation as illustrated and described. Hence, all suitable modifications and equivalents should be considered as falling within the scope of the inventions.

What is claimed is:

1. A method of joining two digital files through an automatic process to create a third digital combination file comprising the steps of:
a. Receiving an uploaded media file in a media file database;
b. Receiving an uploaded advertising file in an advertising database;
c. Selecting a first advertising file to be associated with a second media file;
d. Combining the selected first advertising file and second media file using combination and analytics software engine to create a third, new combination file; and
e. Transmitting the third combined file available to end users without charge through electronic download or streaming

2. The method of claim 1 further comprising the step of compensating the artist based on the number of times each third, new combination file is downloaded or streamed.

3. The method of claim 1 further comprising the step of compensating the artist based on the number of times each media file is added to a personal digital music streaming library.

4. The method of claim 1 wherein the first advertising file is selected by matching a first demographic factor that has been pre-assigned to the advertising file with a second demographic factor that has been pre-assigned to the media file.

5. The method of claim 3 wherein the first demographic factor pre-assigned to the advertising file is selected from the group consisting of age, gender, location, zip code, race, socio-economic status, political view, type/genre of music, artist, and culture.

6. The method of claim 4 wherein the second demographic factor pre-assigned to the media file is selected from the group consisting of age, gender, location, zip code, race, socio-economic status, political view, type/genre of music, artist, and culture.

7. The method of claim 5 wherein the first demographic factor and the second demographic factor are the same.

8. The method of claim 6 wherein the first demographic factor and second demographic factor is type/genre of music.

9. The method of claim 6 wherein the first demographic factor and second demographic factor is age.

10. The method of claim 6 wherein the first demographic factor and second demographic factor is gender.

11. The method of claim 6 wherein the first demographic factor and second demographic factor is location or zip code.

12. The method of claim 3 wherein the first demographic factor pre-assigned to the advertising file is selected from the group consisting of age, gender, location, zip code, and type/genre of music.

13. The method of claim 11 wherein the second demographic factor pre-assigned to the media file is selected from the group consisting of age, gender, location, zip code, and type/genre of music.

14. The method of claim 1 wherein the media file comprises a digital song.

15. The method of claim 13 wherein the media file further comprises a video file.

16. A system for joining two digital files through an automatic process to create a third digital combination file comprising:
a) a media file database;
b) an advertising file database;
c) an ad engine server that is connected to a network and that communicates with the media file database and the advertising file database, and
d) a combination software engine and analytics software provided within the ad engine server that is capable of automatically combining a media file obtained from the media database with an advertising file obtained from the advertising database to create a third, new combination file.

17. The system of claim 15 further comprising an e-commerce server that tracks the number of times a first media file is downloaded or streamed and compensates the artist of the first media file in proportion to the downloaded or streamed number.

18. The system of claim 15 further comprising an e-commerce server that tracks the number of times a first media file is downloaded or streamed and compensates the artist of the first media file in proportion to the number of times the third new combination file is downloaded or streamed to the end user.

19. The system of claim 15 wherein the media file is a digital song.

20. The system of claim 15 wherein the media file includes a video file.
